(19) United States
(12) Patent Application Publication
(10) Pub. No.: US 2002/0147926 A1
(43) Pub. Date: Oct. 10, 2002

(54) Method and apparatus for authentication using remote multiple access SIM technology

(76) Inventors: Mark E. Pecen, Palatine, IL (US); Niels Peter Skov Andersen, Roskilde (DK); Michael Kotzin, Buffalo Grove, IL (US)

Correspondence Address: Michael C. Soldner, Motorola, Inc., Intellectual Property Section, Law Department, 600 North U.S. Highway, Libertyville, IL, 60048, US

(21) Appl. No.: 09/826,181

(22) Filed: Apr. 4, 2001

(51) Int. Cl. G06F 15/173

(52) U.S. Cl. 713/201

(57) ABSTRACT

A method and apparatus for authentication of a client device (256) utilizing remote multiple access to a server device (200) that includes a first authentication application unit (420), positioned within the client device, and a second authentication application unit (408) positioned in the server device. The first authentication application unit transmits a first synchronization command (500) to the server device over the packet data network (424), and the second authentication application unit generates a user unit code and transmits (502) the generated user unit code to the client device over the packet data network in response to the first synchronization command. The first authentication application unit and the second authentication application unit store the generated user unit code, and the server device transmits a message (508) that includes a control command and the user unit code stored in the second authentication application unit to the client device over the packet data network. The first authentication application unit compares the user unit code received in the message with the user unit code stored in the client device and executes (510) the control command in response to the user unit code stored in the client device being the same as the user unit code received in the message.

### FIELD OF THE INVENTION

The present invention relates generally to mobile telecommunications systems utilizing a subscriber identity module, and in particular, the present invention relates to a method and apparatus for remote access to a subscriber identity module.

### BACKGROUND OF THE INVENTION

In a Global System for Mobile Communication (GSM) system and in other telecommunications systems, a mobile device includes hardware and software specific to a radio interface, along with subscriber specific data located in a subscriber identity module, or “SIM”. The SIM can either be a smart card having physical dimensions similar to the well-known size of credit cards, or alternately can be “cut” to a much smaller format, commonly referred to as a “plug-in SIM”. In either case, the SIM card contains and organizes information, such as identity information identifying the subscriber as a valid subscriber, subscriber supplied information, such as telephone numbers, for example, operator specific information, and a certain subset of mobility management state information, such as information about the last public land mobile network in which the mobile device was registered. In this way, when inserted within a mobile device in a cellular network, the SIM card enables the mobile device to be personalized, or associated with subscriber specific information. However, once the SIM card is removed, the mobile device cannot be used, except, if permitted by the network, for emergency related transmissions.

FIG. 1 (Prior Art) is a schematic diagram of known system architecture of a SIM card interface within a mobile device. As illustrated in FIG. 1, a SIM card 100 interfaces with a software component portion 102 of a mobile device through an electrical interface 104 that is coupled to a SIM physical data interchange layer 106 of software component portion 102. Software component portion 102 also includes a SIM authentication and ciphering unit 108, a SIM command/response interface 110, and a SIM physical presence detection unit 112.

Commands corresponding to authentication and ciphering requests that are received and transmitted internally by the mobile device are converted by SIM command/response interface 110 to a standardized command format. The standardized command is then transmitted to SIM authentication and ciphering unit 108 for authentication and cipher key generation, and is then transmitted to SIM physical data interchange layer 106. Commands corresponding to requests other than authentication and ciphering requests that are received and transmitted internally by the mobile device are converted by SIM command/response interface 110 to a standardized command format, and the standardized command is then transferred directly to physical data interchange layer 106. Physical data interchange layer 106 formats the standardized command received from either SIM authentication and ciphering unit 108 or directly from SIM command/response interface 110 into physical data according to GSM required electronic signals and transmission protocols. The physical data is then transmitted from SIM physical data interchange layer 106 to SIM card 100 through electrical interface 104.

Upon receiving the command, SIM card 100 subsequently transmits physical data corresponding to a response to the command from SIM card 100 to physical data interchange layer 106, through electrical interface 104. Physical data interchange layer 106 formats the physical data into a standardized response. The standardized response, if made in response to an authentication and ciphering command, is transmitted to SIM authentication and enciphering unit 108 for authentication and cipher key generation, and then to SIM command/response interface 110, which converts the standardized response to a format required internally by the mobile station. Standardized responses to commands corresponding to requests other than authentication and ciphering requests are transmitted directly from physical data interchange layer 106 to SIM command/response interface 110, which converts the standardized response to a format required internally by the mobile device.

Throughout the internal command and response generation process described above, electrical interface 104 continuously transmits a physical presence signal to a physical presence detection unit 112 to indicate that SIM card 100 is inserted and is in electrical contact with electrical interface, and that SIM card 100 is functioning properly. Once the physical presence signal is interrupted, such as when SIM card 100 has been removed or fails, and is therefore no longer detected by physical presence unit 112, physical presence detection unit 112 transmits an interrupt signal indicating the absence of SIM card 100, and service access to the mobile device is interrupted.

The SIM card, as defined by GSM specifications, has been further enhanced in terms of information organization and functionality for use with other services. For example, work for the Telecommunications Industry Association/Electronics Industry Association (TIA/EIA) 136 Enhanced General Packet Radio Services (EGPRS) for TIA/EIA 136 proposes the use of the European GSM SIM card plus enhancements for use by the American time division multiple access (TDMA) proposed high-speed wireless data service. The current GSM definition of the SIM card will likely be expanded to include other services as well, such as third generation mobile voice and data services.

One of the disadvantages that will result as the SIM card is utilized in more and more subscriber devices, is that a separate SIM card will be required for use in each subscriber device, and therefore a user of multiple SIM card enabled devices will be required to utilize a multiple number of SIM cards. Accordingly, what is needed is a method and apparatus that enables multiple SIM card enabled subscriber devices to be utilized using a single SIM card.

### BRIEF DESCRIPTION OF THE DRAWINGS

The features of the present invention which are believed to be novel are set forth with particularity in the appended claims. The invention, together with further objects and advantages thereof, may best be understood by making reference to the following description, taken in conjunction with the accompanying drawings, in the several figures of which like reference numerals identify like elements, and wherein:

FIG. 1 (Prior Art) is a schematic diagram of known system architecture of a SIM card interface within a mobile device.

FIG. 2 is a schematic diagram of a communications system enabling remote multiple access to a single SIM card device, according to the present invention.

FIG. 3A is a schematic diagram of system architecture of a server device enabling remote multiple access to a SIM card, according to the present invention.

FIG. 3B is a schematic diagram of system architecture of a client device, according to the present invention.

FIG. 4 is a flowchart of processing of a SIM command message by a remote client device, according to the present invention.

FIG. 5 is a flowchart of processing a SIM command received by a server device, according to the present invention.

FIG. 6 is a flowchart of routing of a received SIM command by a server device, according to the present invention.

FIG. 7 is a schematic diagram of authentication of remotely executed transactions according to the present invention.

FIG. 8 is a schematic diagram of message sequencing during a key synchronization process for authentication of remote multiple access to a single SIM card device, according to the present invention.

FIG. 9 is a schematic diagram of message sequencing for authentication of remote multiple access to a single SIM card device, according to the present invention.

FIGS. 10 and 11 are flowcharts of a key synchronization process for authentication of remote multiple access to a single SIM card device, according to the present invention.

FIGS. 12 and 13 are flowcharts of authentication of remote multiple access to a single SIM card device, according to the present invention.

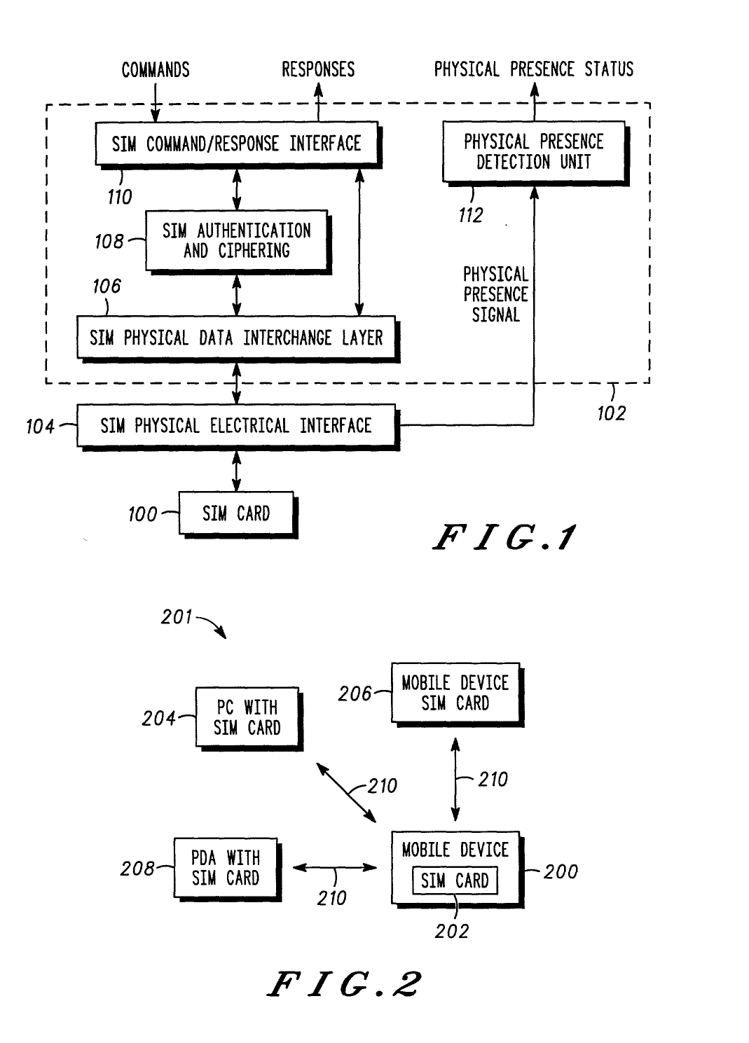

### DETAILED DESCRIPTION OF THE PREFERRED EMBODIMENT

The present invention is a method and apparatus for authenticating a mobile device, in a mobile telecommunications system that enables a client device to remotely access a packet data network through a server device, during a transaction requiring increased security over and above the security inherent in the remote access to the packet data network. An authentication application unit positioned within the client device, transmits a first synchronization command to the server device over the packet data network, and an authentication application unit positioned within the server device generates a user unit code and transmits the generated user unit code to the client device over the packet data network in response to the first synchronization command. The generated user unit code is stored by the client device and by the server device and the server device transmits a message to the client device over the packet data network, the message including a control command and the user unit code stored in the server device. The authentication application unit of the client device compares the user unit code received in the message with the user unit code stored in the client device and executes the control command in response to the user unit code stored in the client device being the same as the user unit code received in the message.

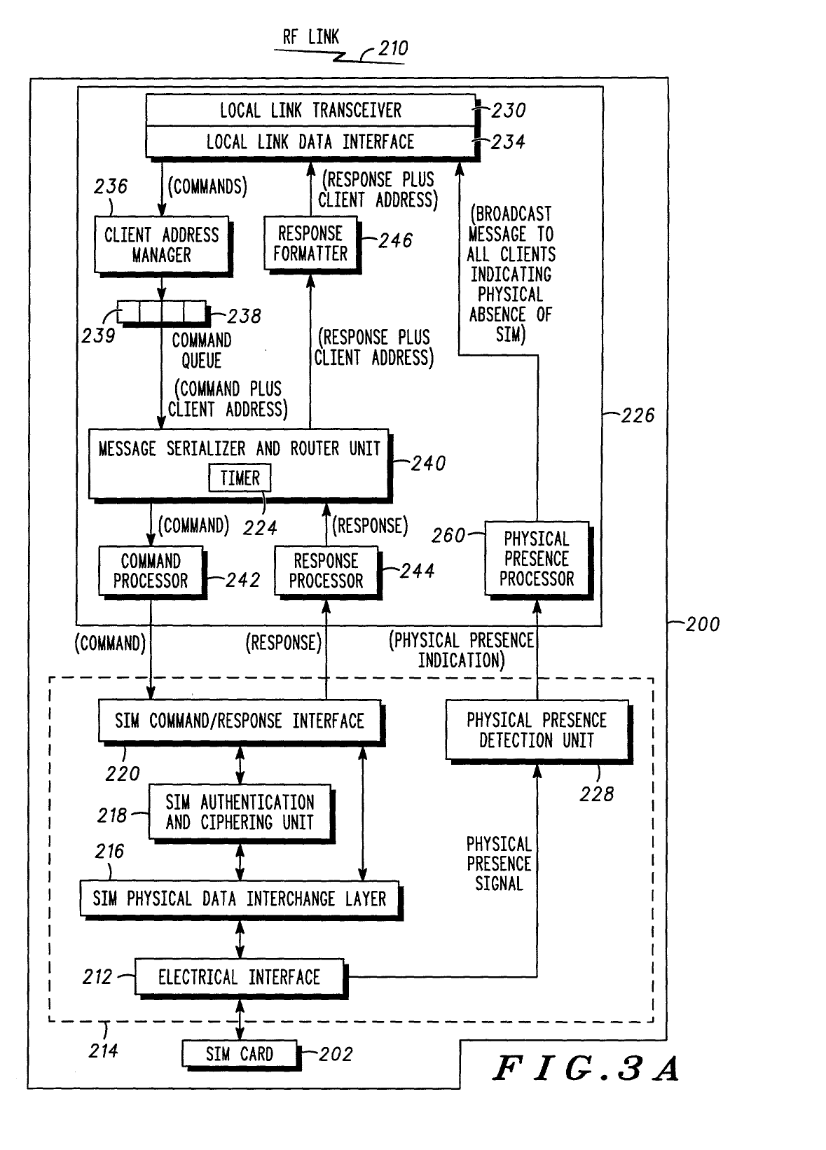

FIG. 2 is a schematic diagram of a communications system enabling remote multiple access to a single SIM card device, according to the present invention. As illustrated in FIG. 2, a communication system 201 according to the present invention includes a server device 200, such as a mobile subscriber unit, having a SIM card 202 intended for use by a single user inserted within server device 200. Other client devices, such as a personal computer 204, another mobile subscriber unit 206, and a personal digital assistant (PDA) 208, which are intended to operate utilizing a SIM card, interface with server device 200 via local links 210. According to the present invention, local links 210 can be hardwire connections or wireless connections, such as Bluetooth links, pico-radio, or other known wireless transmission technology. Therefore, although the present invention will be described below as utilizing a wireless local link for transmitting commands and responses between server device 200 and client devices 204, 206 and 208, it is understood that the present invention could also be realized using a hardwire connection as local link 210.

Server device 200 may be a mobile subscriber unit that is intended for General Packet Radio Service (GPRS) data interchange, while mobile subscriber unit 206 may be capable of voice-only service. It is understood that while three client devices 204, 206 and 208 are shown in FIG. 2, the present invention is intended to include any number of and/or variety of client devices that utilize a SIM card.

According to the present invention, each of client devices 204, 206 and 208 is able to access SIM card 202 in server device 200 via wireless link 210, as will be described below, thereby alleviating the need for a separate SIM card to be inserted within each of client devices 204, 206 and 208. As a result, by enabling remote, multiple access to the services of a single SIM card by multiple subscriber devices, the present invention enables GSM and Universal Mobile Telephone System (UMTS) operators to offer their customers multiple services, or services that would span more than one physical terminal unit, with provisioning of a single SIM card. Since the range of the wireless local link 210 is limited, the operator has a built-in device which limits the usage of the multiple subscriptions to a single user, or to a very small multi-user environment.

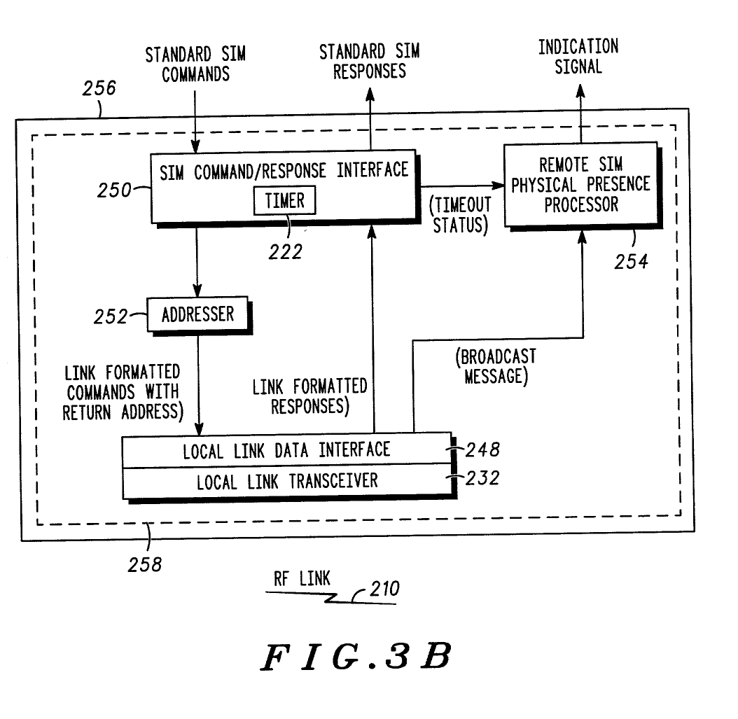

FIG. 3A is a schematic diagram of system architecture of a server device enabling remote multiple access to a SIM card, according to the present invention. As illustrated in FIGS. 2 and 3A, in addition to SIM card 202, server device 200 includes a SIM card interface 214 and a router unit 226. An electrical interface 212 enables hardware associated with SIM card 202 to interface with SIM card interface 214 of server device 200. SIM card interface 214 includes a SIM physical data interchange layer 216 that receives electrical signals from electrical interface 212, and a SIM authentication and ciphering unit 218 which establishes an authenticated connection prior to the provision of information services to client devices 204, 206 and 208.

A SIM command/response interface 220 of SIM card interface 214 receives commands from router unit 226 and converts response information, formatted internally by SIM card interface 214, to standardized responses which are sent to a router unit 226. In addition, SIM card interface 214 includes a physical presence detection unit 228 that receives an electrical signal transmitted directly from electrical interface 212 when SIM card 202 is inserted within server device 200 to indicate the physical presence of SIM card 202 within server device 202. As long as the physical presence signal is detected, physical presence detection unit 228 continuously transmits a physical presence indication signal to a physical presence processor 260 of router unit 226. When SIM card 202 is not inserted in server device 200, receipt of the physical presence indication signal from physical presence detection unit 228 is interrupted, and physical presence processor 260 transmits a broadcast message along local link 210 through a local link transceiver 230. In this way, server device 200 transmits the broadcast message to each of client device 204, 206 and 208 that are currently attached to server device 200 via local link 210, indicating that SIM card 202 is not electrically coupled at electrical interface 212 of SIM interface 214 of server device 200.

Local link transceiver 230 within router unit 226 performs local link and address management and authentication to enable data to be interchanged via local link 210, between server device 200 and any one of multiple client devices 204, 206 and 208. A local link data interface 234 performs bidirectional conversion of commands from client devices 204, 206 and 208 that are received by router unit 226, and of responses transmitted from router unit 226 to client devices 204, 206 and 208 to a message format that is meaningful and useful to a client address manager 236 and local link transceiver 230, respectively. Local link data interface 234 formats the commands from local link transceiver 230 and converts the responses to the commands from SIM card 202 and the broadcast message from physical presence processor 260 to a format corresponding to local link transceiver 230, and local link transceiver 230 transmits the responses to the commands from local link data interface 234 to client devices 204, 206 and 208 along local link 210.

Client address manager 236 receives commands from data interface 234, associates the commands with a local link address to determine whether the client devices from which the commands originated are permitted client devices 204, 206 and 208, and determines whether a number of allowed remote SIM clients has been exceeded by server device 200. In this way, valid commands are formed when the commands are determined to originate from permitted client devices 204, 206 and 208, and server device 200 has service capacity, as provisioned by a service provider. As a result, if a command is received and server device 200 is serving a maximum number of client devices 204, 206 and 208, or a client device associated with the command is not permitted service, the command is discarded by server device 200.

In addition, server device 200 includes a maximum response timer 224 that determines the amount of time between the transmission of commands by router unit 226 to SIM card 202, and receipt of responses to the commands from SIM card 202. If timer 224 exceeds a predetermined amount of time, the commands are discarded. Although timer 224 is shown in FIG. 3A as being located in message serializer and router unit 240, it is understood that, according to the present invention, timer 224 may be positioned at other locations within router unit 226.

As commands are received by client address manager 238, the received commands are stored in order of receipt in a command queue buffer 238, with the first command received being located at a head 239 of command queue 238. The received commands are each processed individually by a message serializer and router unit 240, as described below, and the processed commands are sent from message serializer and router unit 240 to a command processor 242. Command processor 242 formats the commands and sends a corresponding command to SIM card 202 via command/response interface 220, SIM authentication and ciphering unit 212, data interchange layer 216, and electrical interface 212.

A response processor 244 receives and formats a response to the command from SIM card 202 via command/response interface 220, and sends the response to message serializer and router 240. Message serializer and router 240 associates the response with client device address information, and transmits the response to a response formatter 246. Response formatter 246 formats and converts the response and the associated address to a response message that is transmitted to data interface 234 and sent to client devices 204, 206 and 208 corresponding to the associated address via local link 210 by transceiver 230.

FIG. 3B is a schematic diagram of system architecture of a client device, according to the present invention. It is understood that, according to the present invention, each of client devices 204, 206 and 208 is capable of interfacing with server device 200, as illustrated in FIG. 2. However, since client devices 204, 206, and 208 each include system architecture corresponding to the present invention, only one client device 256 is shown in FIG. 3B, merely to simplify the discussion, and the description of client device 256 therefore is intended to describe features associated with each of client devices 204, 206, and 208.

As illustrated in FIGS. 2-3B, a local link data interface 248 of client device 256 performs bidirectional conversion of internal messages to and from router unit 226 through a local link transceiver 232 in a message format that is meaningful and useful to router unit 226 and to a command/response interface 250 of client device 256. Transceiver 232 performs local link and address management and authentication of the broadcast message and the responses to the commands received along local link 210 from server device 200 via transceiver 230. Data interface 248 converts the commands from addresser 252 to a format corresponding to transceiver 232 to enable transceiver 232 to transmit the commands from data interface 248 to transceiver 230 of server device 200 along local link, and converts the broadcast message and the responses to the commands from SIM card 202 to a format corresponding to command response interface 250.

Command/response interface 250 converts command and response information that has been formatted internally by client device 256 to standardized commands and responses specified for SIM card interchange. In this way, command/response interface 250 converts internal information to form the commands, and links the responses to the commands from SIM card 202 with the internal information. The standard SIM commands from command/response interface 250 are received by an addresser 252, which associates a local client address to the command. The commands are then output by transceiver 232 of client device 256 along local link 210, and are received through transceiver 230 by router unit 226 and routed to SIM card 202 through electrical interface 212.

Client device 256 includes a remote SIM physical presence processor 254 that receives the broadcast message transmitted along local link 210 from server device 200 in response to SIM card 202 not being electrically coupled at electrical interface 212 of SIM interface 214 of server device 200. In this way, if SIM card 202 is removed from server device 200, or a SIM card failure has occurred, physical presence detection unit 228 will not received the physical presence signal from electrical interface 212, so that the transmission of the physical presence indication signal to physical presence processor 260 will be interrupted, thereby causing the broadcast message to be transmitted from physical presence processor 260 to physical presence processor 254, which in turn transmits the indication signal informing client device 256 of the absence or failure of SIM card 202. As a result, the present invention enables SIM card 202 to appear as though it resides on client device 256.

A maximum response timer 222 determines the amount of time between the commands being transmitted by client devices 204, 206 and 208 along local link 210 to server device 200, and receipt of the responses to the commands from SIM card 202 transmitted along local link 210 from router unit 226. If timer 224 exceeds a predetermined period of time, timer 222 transmits a timeout message to physical presence processor 254, which then transmits the indication signal informing client device 256 of the absence or failure of SIM card 202. In this way, physical presence processor 260 detects the presence of the actual SIM card 202, and if SIM card 202 is removed from server device 200, physical presence processor 260 transmits the broadcast message, via wireless link 210, to all client devices 204, 206 and 208 informing of the absence of SIM card 202. Remote physical absence processor 254 of each client device 204, 206 and 208 transmits an indication signal, upon receipt of the broadcast message form physical presence processor 260 or the timeout message from timer 222, internally indicating to client devices 204, 206 and 208 that SIM card 202 was removed from server device 200, or that server device 200 has not responded to a command within a predetermined period of time. As a result, SIM card 202 appears logically to client device 256 as SIM card 202 resides within client device 256.

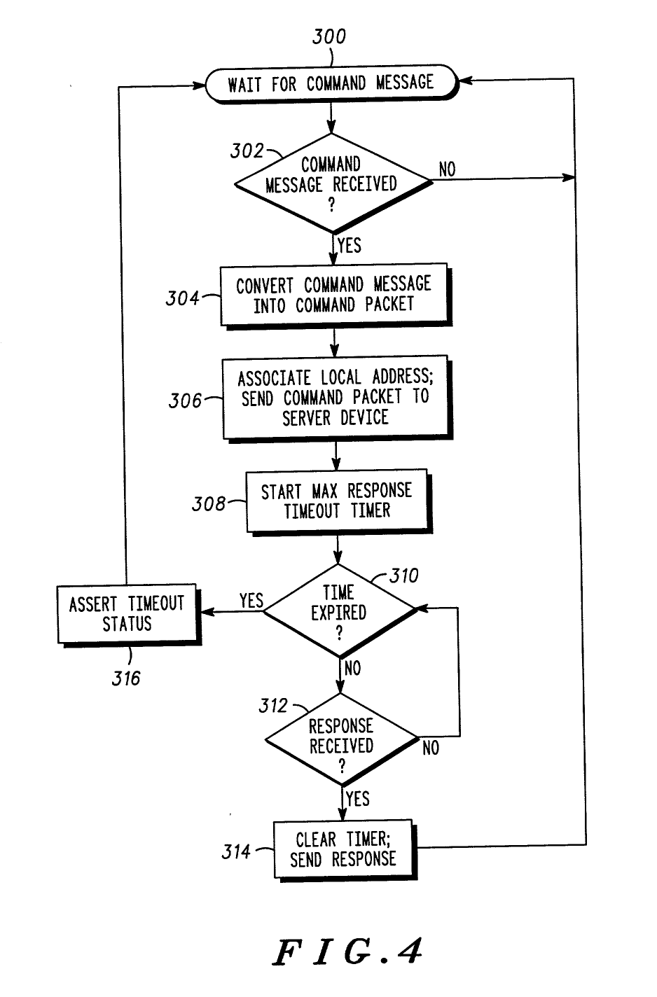

FIG. 4 is a flowchart of processing of a SIM command message by a remote client device, according to the present invention. As illustrated in FIGS. 3A, 3B and 4, according to the present invention, client device 256 waits to receive an internal SIM command message, Step 300, and once a SIM command message is received, Step 302, the received SIM command message is converted by command response interface 250 into a command packet, Step 304, that is usable by interface 248. The command packet is transmitted to addresser 252, which associates a local address identifying client device 256 with the command packet, and the command packet and local address is then transmitted to server device 200 via local link 210 and transceivers 230, 232 in Step 306. Once the command packet has been transmitted to server device 200 in Step 306, maximum response timeout timer 222 positioned within client device 256 is started, Step 308, to keep track of the amount of time between the sending of the command packet to server device 200 and receipt of a response to the command from SIM card 202 from server device 200.

A determination is made in Step 310 as to whether maximum response timeout timer 222 has expired, i.e., whether the amount of time between the sending of the command packet to server device 200 and receipt of a response to the command message from server device 200 is greater than or has exceeded a predetermined amount of time. If timer 222 has not exceeded the predetermined time period, a determination is then made as to whether a response from server device 200 to the command packet from SIM card 202 has been received by client device 256 from server device 200, Step 312. If a response has not been received, the process returns to Step 310.

If it is determined that timer 222 has not expired and a response has been received, timer 222 is cleared and the received response is transmitted internally within client device 256 via command response interface 250, Step 314. However, if, prior to determining in Step 312 that a response has been received, it is determined in Step 310 that maximum response timeout timer 222 has exceeded the predetermined time period, a timeout status is asserted to remote physical absence processor 254 in Step 316, which in turn internally signals client device 256 to indicate to client device 256 that there was a response failure.

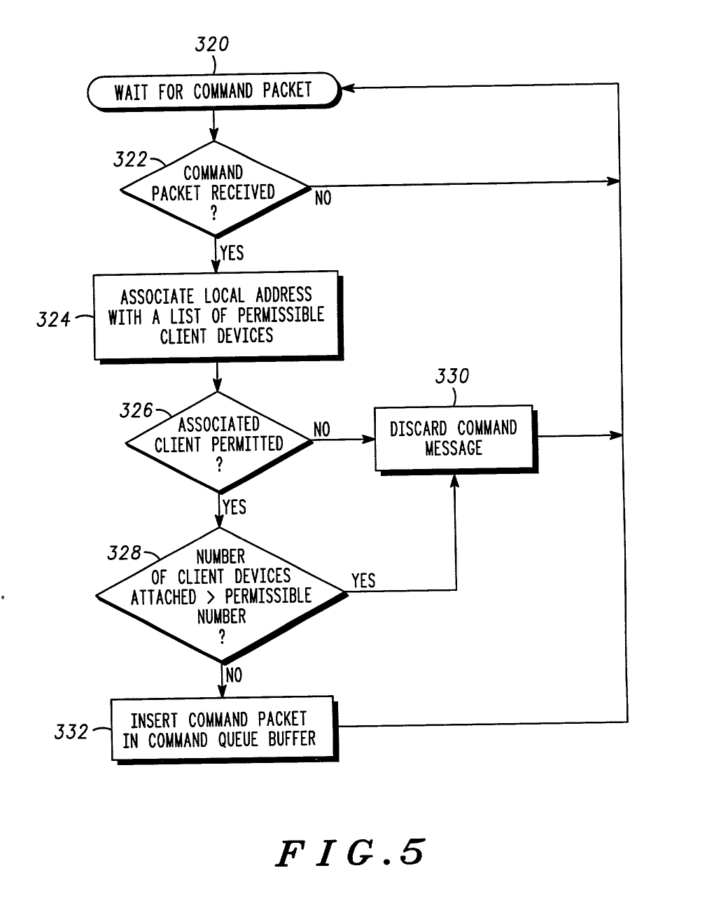

FIG. 5 is a flowchart of processing of a SIM command received by a server device, according to the present invention. As illustrated in FIGS. 3 and 5, according to the present invention, client address manager 236 waits to receive a command packet from client device 256, Step 320, and once a command packet is received, Step 322, client address manager 236 compares the local link address previously associated by addresser 252 with a list of permissible client devices, Step 324. Based upon this comparison by client address manager 236, a determination is made as to whether client device 256 is included in the list of permissible client devices and is therefore a permitted device, Step 326, and as to whether server device 200 has more than a maximum number of permissible client devices currently attached, Step 328.

According to the present invention, the maximum number of permissible client devices can be controlled by the GSM or UMTS operator, enabling the operator to limit the number of remote connections permissible, and that the number could be zero, so that the operator could permit or deny remote SIM operation. According to the present invention, identification of the number of remote clients that SIM card 202 can support can be identified, for example, in an answer to reset, or ATR message, which is a response currently defined within GSM standards and in which there are currently several unused characters that are sent. Therefore, according to a preferred embodiment of the present invention, the identification of the number of remote clients that SIM card 202 can support is contained in an unused character of the ATR message. However, it is understood that the identification of the number of remote clients that SIM card 202 can support could be conveyed in other messages or by alternate procedures.

If it is determined in Step 326 that the associated client device is not permitted service, or if it is determined in Step 328 that server device 200 is currently serving a maximum number of client devices allowed for that server device, the command packet is discarded, Step 330 and the process returns to Step 320 to wait for receipt of a next command packet.

However, if it is determined in Step 326 that the associated client device is permitted service, and it is determined in Step 328 that server device 200 is not currently serving a maximum number of client devices allowed for that server device, the command packet, including the associated internal representation of the address of the command packet previously associated by addresser 252 is enqueued in command queue buffer 238 in Step 332, and the process returns to Step 320 to wait for receipt of a next command packet by client address manager 236.

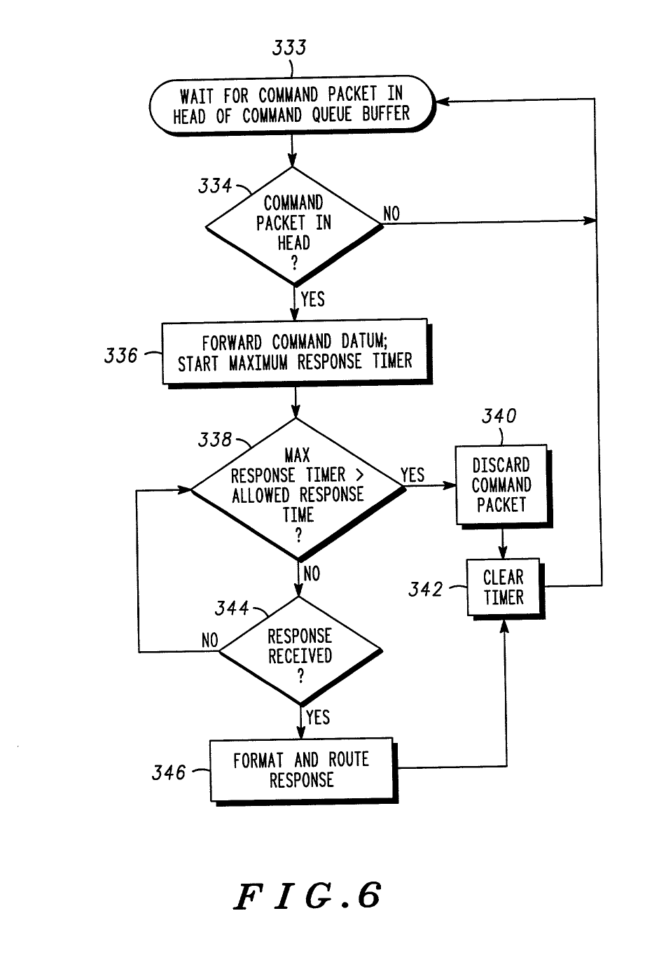

FIG. 6 is a flowchart of routing of a received SIM command by a server device, according to the present invention. As illustrated in FIGS. 3 and 6, according to the present invention, message serializer and router 240 waits for a command packet to be inserted at head 239 of command queue buffer 238, Step 333, and once a determination is made in Step 334 that command packet is in head 239 of command queue buffer 238, message serializer and router 240 removes the command packet from head 239 of command queue buffer 238, forwards the command packet to command processor 242, and starts maximum response timer 224, Step 336.

Maximum response timer 224 keeps track of the amount of time between transmission of the commands by router unit 226 to SIM card 202, and receipt of the responses to the commands from SIM card 202. In particular, timer 224 keeps track of the amount of time that expires between the forwarding of the command packet by message serializer and router 240 to command processor 242 and receipt of a response to the command packet by message serializer and router 240. Once timer 224 has been started, a determination is then made in Step 338 as to whether the time displayed by maximum response timer 224 is greater than a predetermined response time. If the time displayed by the maximum response timer 224 is greater than the predetermined response time, the command packet is discarded, Step 340, the timer is cleared, Step 342, and the process returns to Step 333 and waits for a next command packet in head 239 of command queue buffer 238, Step 334.

If it is determined in Step 338 that maximum response timer 224 is not greater than the predetermined response time, a determination is made in Step 344 as to whether a response to the command packet has been received. If a response has not been received, the process returns to Step 338 so that message serializer and router 240 waits until either a response is received, or until the amount of time that has expired since the command packet was forwarded to command processor 242 in Step 336 by message serializer and router 240 has exceeded a predetermined allowed response time. However, if timer 224 has not exceeded the predetermined allowed response time and it is determined in Step 344 that a response to the command packet was received, the response is formatted and routed to the requesting client device 256, Step 346, via response formatter 246, interface 234, and transceiver 230. Maximum response timer 224 is then cleared, Step 342, and the process returns to Step 333 and waits for a next command packet in head 239 of command queue buffer 238, Step 334.

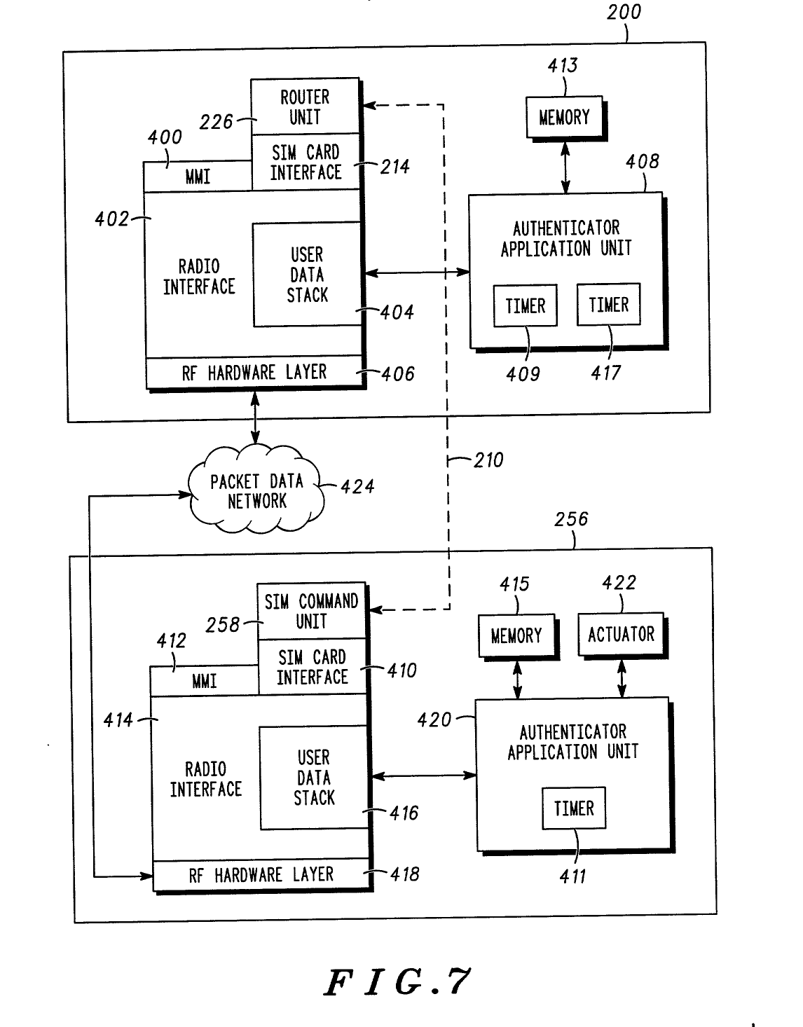

FIG. 7 is a schematic diagram of authentication of remotely executed transactions according to the present invention. As illustrated in FIG. 7, in addition to SIM card interface 214 and router unit 226, server device 200 includes a man-machine interface 400, a radio interface 402 including a General Packet Radio Service (GPRS) user data stack 404, along with several functional layers arranged in hierarchical form, such as, for example, a radio interface layer, a data link layer, and a physical layer (not shown), all located hierarchically above a radio frequency (RF) hardware layer 406, and an authenticator application unit 408. Packet data is transmitted between server device 200 and a packet data network 424 via RF hardware layer 406.

In the same way, in addition to a SIM command unit 258 (FIG. 3B) that includes transceiver 232, data interface 248, command/response interface 250, addresser 252 and physical presence processor 254, client device 256 includes a SIM card interface 410, similar to SIM card interface 214 of server device 200, a man-machine interface 412, a radio interface 414 including a General Packet Radio Service (GPRS) user data stack 416, along with several functional layers arranged in hierarchical form, such as, for example, a radio interface layer, a data link layer, and a physical layer (not shown), all located hierarchically above a radio frequency (RF) hardware layer 418, and an authenticator application unit 420. Packet data is transmitted between client device 256 and packet data network 424 via RF hardware layer 418.

In instances where more than one GSM or UMTS device utilizes a single SIM card using the remote multiple access of the present invention, a certain degree of security or access restriction is desired, over and above the security inherent in the required close proximity of the multiple devices resulting from the limitations of the wireless local link 210. For example, increased security is desired when executing transactions related to accessing an automotive vehicle, home, hotel room or other facility, and so forth.

According to the present invention, for transactions using remote multiple access of the present invention that require this increased security, authentication includes a key synchronization process, which requires that both the client and server devices have a priori knowledge of specific information, such as a “key” or “unit user code” (UUC), and an authentication and operation logic process, corresponding to the normal operational mode by which the basic authentication and processing of commands is performed. The combination of the authentication and operation logic process and the synchronization process performed prior to the authentication and operation logic process of the present invention reduces the probability of the system being compromised by the interception and/or decoding of messages during the system's operational phase.

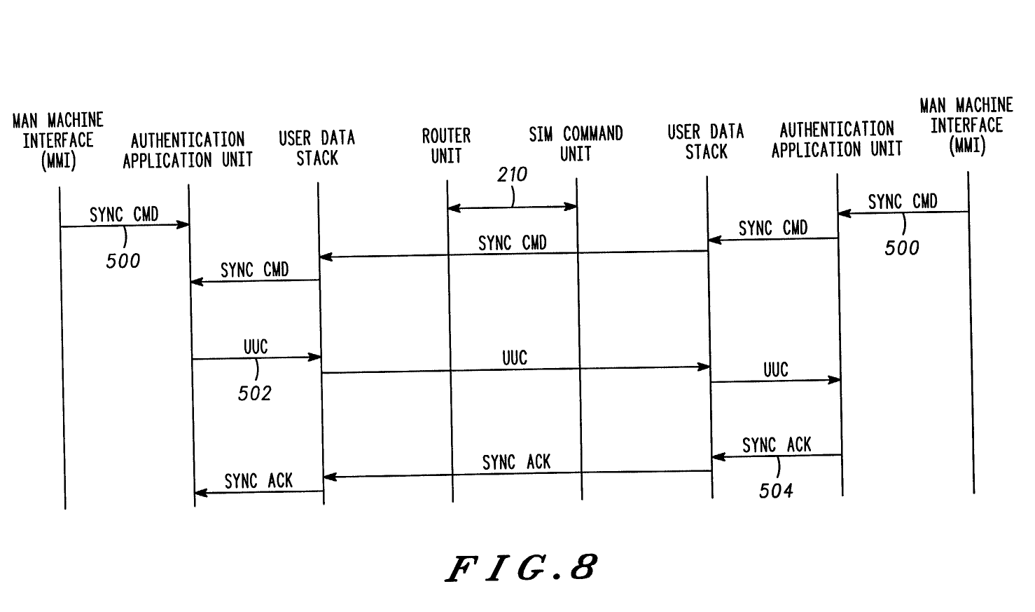

FIG. 8 is a schematic diagram of message sequencing during a key synchronization process for authentication of remote multiple access to a single SIM card device, according to the present invention. Once client device 256 has been enabled to access cellular packet data network 424, using the method and apparatus of the present invention, for remote multiple access to SIM card 202 physically located in server device 200, described above, a user enters a synchronization command 500 on both server device 200 and client device 256, via man machine interfaces 400 and 412, respectively. Once synchronization command 500 is received by authentication application unit 408 of server device 200, a timer 409 located in authentication application unit 408 is started. In the same way, once synchronization command 500 is received by authentication application unit 420 of client device 256, a timer 411 located in authentication application unit 420 is started.

According to the present invention, if the synchronization command 500 is not entered at both server device 200 and client device 256 prior to the expiration of timer 409 or timer 411, the synchronization process is terminated. As a result, by requiring entry of synchronization command 500 at both server device 200 and client device 256 within a predetermined time period, the present invention avoids inadvertent synchronization of client device 256 and server device 200, and enables both server device 200 and client device 256 to have knowledge of the same user code information.

As illustrated in FIGS. 7 and 8, timers 409 and 411 are started upon receipt of synchronization command 500 at authenticator application units 420 and 408 of client device 256 and server device 200, respectively. Once received at authenticator application unit 420 of client device 256, synchronization command 500 is then sent from authenticator application unit 420 to cellular packet data network 424 via GPRS/EDGE user data stack 416 and RF hardware layer 418, and from cellular packet data network 424 to authenticator application unit 408 of server device 200 via RF hardware layer 406 and GPRS/EDGE user data stack 404.

Upon receipt of synchronization command 500, authenticator application unit 408 computes and temporarily stores a user unit code (UUC), which is a pseudo random, unique identifier, in a memory 413. A message 502 containing the user unit code is sent from authenticator application unit 408 to GPRS/EDGE user data stack 404 and transmitted to client device 256 over an encrypted GPRS/EDGE link via RF hardware layer 406, cellular packet data network 424, and RF hardware layer 418. Upon receipt of message 502 by authenticator application unit 420 of client device 256 from GPRS/EDGE user data stack 416, authenticator application unit 420 stores the user unit code in a storage device or memory 415, stops timer 411, and sends a synchronization acknowledgement message 504 to server device 200 via GPRS/EDGE user data stack 416, RF hardware layer 418 and cellular packet data network 424. Upon receipt at RF hardware layer 406, synchronization acknowledgement message 504 is sent to authenticator application unit 408 of server device 200 from GPRS/EDGE user data stack 404. Authenticator application unit 408 then moves the new user unit code from temporary storage to long-term storage in memory 413, making the user unit code available for operational use, and stops timer 409.

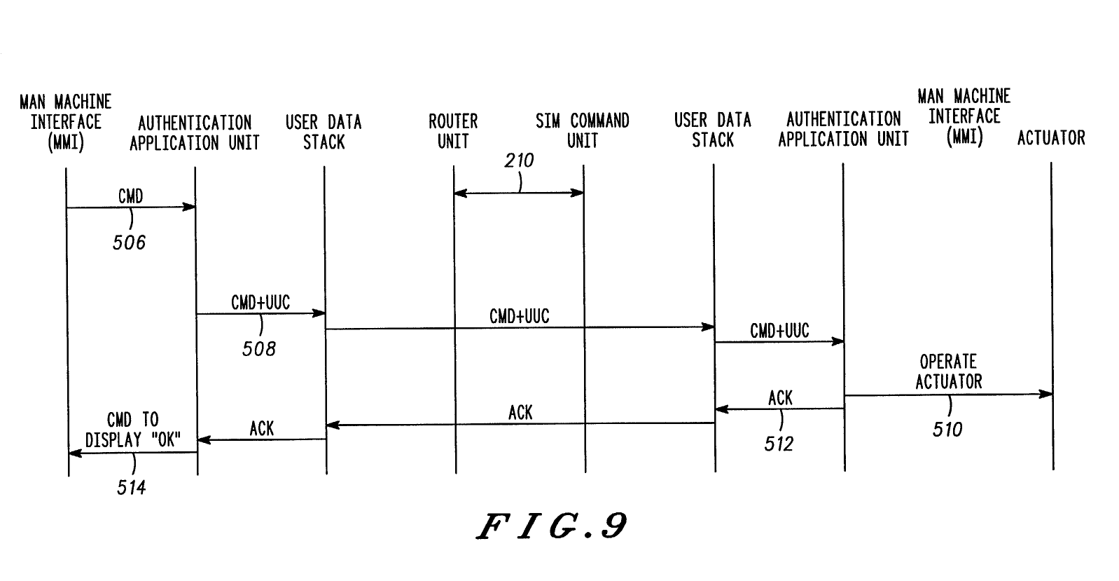

FIG. 9 is a schematic diagram of message sequencing for authentication of remote multiple access to a single SIM card device, according to the present invention. As illustrated in FIGS. 7 and 9, after completion of the synchronization process of the present invention, and the user enters a command 506 associated with a transaction requiring increased security or access restriction on man-machine interface 400, which then sends command 506 to authentication application unit 408.

According to the present invention, upon receipt of command 506 via GPRS/EDGE user data stack 404, a timer 417 located in authentication application unit 408 is started and authenticator application unit 408 combines command 506 with the stored user unit code. A message 508 containing the combined command and user unit code (CMD+UCC) is sent from authenticator application unit 408 to GPRS/EDGE user data stack 404 and is transmitted to client device 256 over the encrypted GPRS/EDGE link via RF hardware layer 406, cellular packet data network 424, and RF hardware layer 418. Upon receipt of message 508 from GPRS/EDGE user data stack 416 of client device 256, authenticator application unit 420 compares the user unit code of message 508 to the user unit code previously stored by authenticator application unit 420 in memory 415, and if the user unit code received with the control command in message 508 is the same as the user unit code stored in memory 415, a command message 510 is sent from authenticator application unit 420 to actuator 422 and the execution of the control command is performed. However, if the user unit code received with the control command in message 508 is determined by authenticator application unit 420 not to be the same as the user unit code stored in memory 415, execution of the control command is terminated and actuator 422 is not operated.

When command message 510 is sent, authenticator application unit 420 updates the user unit code stored in memory 415, using a predetermined algorithm that moves the value of the user unit code to the next value in a non-sequential manner, and sends an acknowledgement message 512 to server device 200 via GPRS/EDGE user data stack 416, RF hardware layer 418 and cellular packet data network 424. Upon receipt at RF hardware layer 406, acknowledgement message 512 is sent from GPRS/EDGE user data stack 404 of server device 200 to authenticator application unit 408. Upon receipt of acknowledgement message 512, authentication application unit 408 sends a command message 514 to man-machine interface 400 which displays an indication informing the user that command 506 was completed successfully, stops timer 417, and updates the user unit code stored in memory 413 using the same predetermined algorithm as authenticator application unit 420 to change the value of the user unit code to the next value in a non-sequential manner. By updating the user unit code using a predetermined algorithm at both authenticator units 408 and 420, the present invention alleviates the need to transmit the updated user unit code over a public or semi-public medium, thereby increasing security.

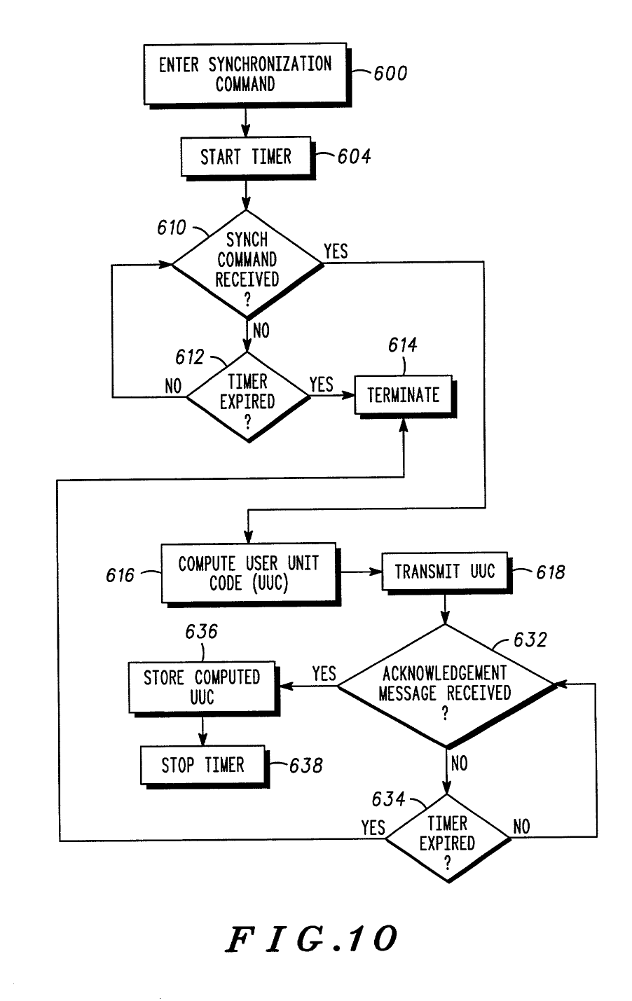

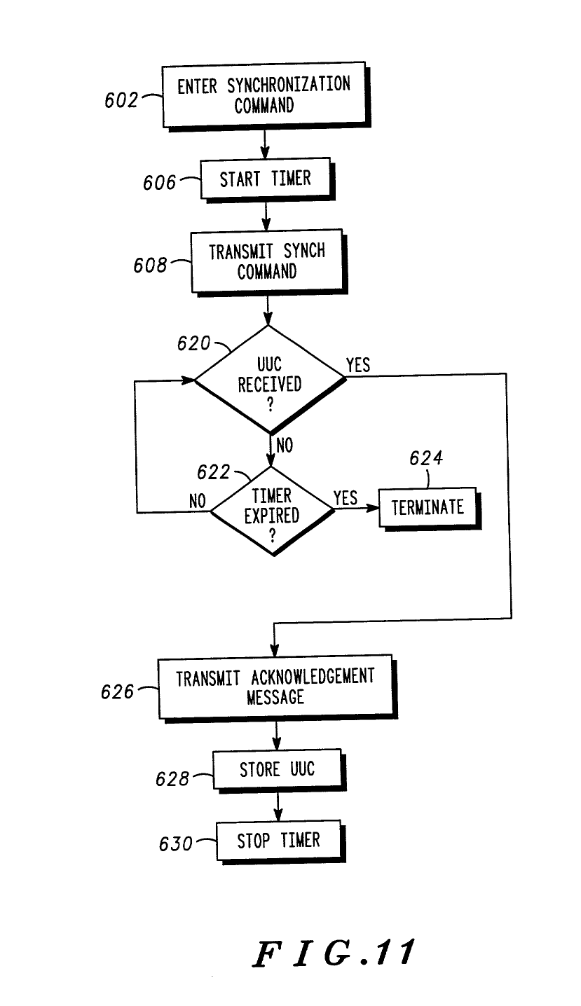

FIGS. 10 and 11 are flowcharts of a key synchronization process for authentication of remote multiple access to a single SIM card device, according to the present invention. As illustrated in FIGS. 10 and 11, a user initially enters a synchronization command at server device 200, Step 600, and at client device 256, Step 602, which causes timers 409 and 411 in server device 200 and client device 256 to be started, Steps 604 and 606, respectively. Client device 256 then transmits the synchronization command to server device 200 over the encrypted GPRS/EDGE cellular packet data network, Step 608.

Once timer 409 is started, Step 604, server device 200 determines whether the synchronization command has been received from client device 256, Step 610. If the synchronization command has not been received, a determination is made as to whether timer 409 has expired, Step 612. If timer 409 has expired, the synchronization process is terminated, Step 614. On the other hand, if it is determined in Step 612 that timer 409 has not expired, the synchronization process returns to Step 610. In this way, if the synchronization command is not received by server device 200 from client device 256 within a predetermined time period, the synchronization process is aborted, Step 614.

If it is determined in Step 610 that the synchronization command has been received and it is determined in Step 612 that timer 409 has not expired, the synchronization command has been received within the predetermined time period. Server device 200 then computes the pseudorandom user unit code, Step 616, and transmits the user unit code to client device 256 over the encrypted GPRS/EDGE cellular packet data network, Step 618.

As illustrated in FIG. 11, once the synchronization command is transmitted by client device 256 to server device 200, Step 608, client device 256 then determines whether the user unit code has been received from server device 200, Step 620. If the user unit code has not been received, a determination is made as to whether timer 411 has expired, Step 622, and if timer 411 has expired, the synchronization process is terminated, Step 624. On the other hand, if it is determined in Step 622 that timer 411 has not expired, the synchronization process returns to Step 620. In this way, if the user unit code is not received by client device 256 from server device 200 within a predetermined time period, the synchronization process is aborted, Step 624.

If it is determined in Step 620 that the user unit code has been received and it is determined in Step 622 that timer 411 has not expired, the user unit code has been received by client device 256 within the predetermined time period. Client device 200 then transmits an acknowledgement message to server device 200 over the encrypted GPRS/EDGE cellular packet data network, Step 626, stores the user unit code, Step 628, and stops timer 411, Step 630.

As illustrated in FIG. 10, after transmitting the user unit code to client device, Step 618, server device makes a determination as to whether the acknowledgement message has been received from client device 256, Step 632. If it is determined in Step 632 that the acknowledgement message has not been received from client device 256, a determination is then made as to whether timer 409 has expired, Step 634. If timer 409 has not expired, the synchronization process returns to Step 632. On the other hand, if it is determined in Step 634 that timer 409 has expired, the synchronization process is terminated, Step 614.

If it is determined in Step 632 that the acknowledgement message has been received from client device 256, server device 200 stores the user unit code in memory 413, Step 636, and stops timer 409, Step 638, to end the synchronization process. In this way, according to the present invention, the synchronization process causes server device 200 and client device 256 to synchronize their knowledge of specific information, in this case the last user unit code that was used to authenticate the user, and avoids inadvertent synchronization between server device 200 and client device 256.

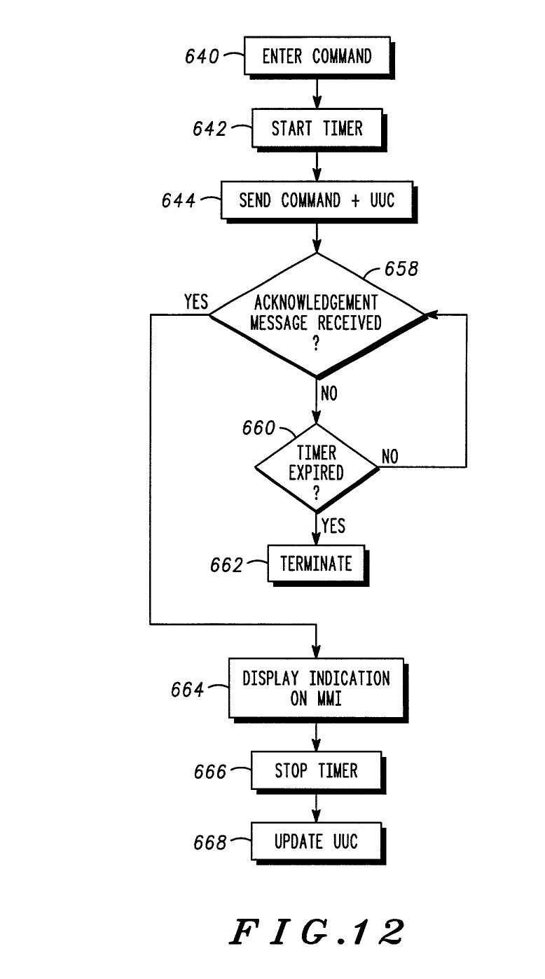

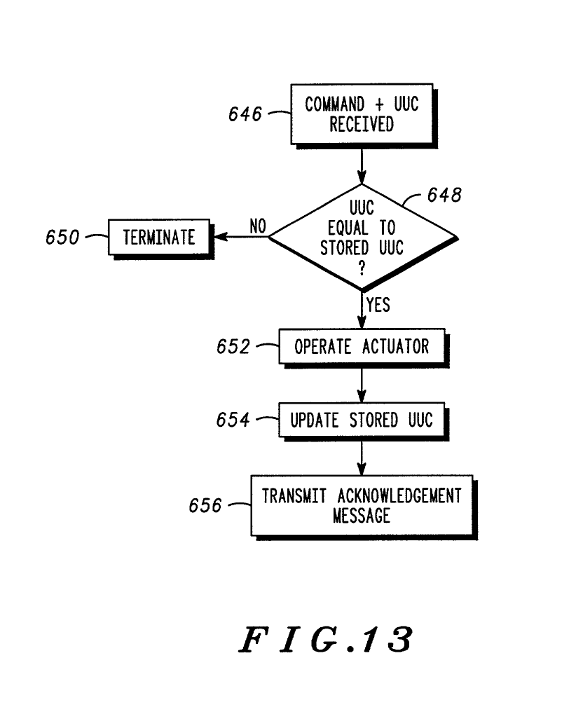

FIGS. 12 and 13 are flowcharts of authentication of remote multiple access to a single SIM card device, according to the present invention. As illustrated in FIGS. 12, once the synchronization process according to the present invention, has been completed, and a command associated with a transaction requiring increased security or access restriction has entered by the user, Step 640, timer 417 in server device 200 is started, Step 642. Server device 200 then sends the command, along with the computed user unit code to client device 256 over the encrypted GPRS/EDGE cellular packet data network, Step 644.

As illustrated in FIG. 13, once the command and user unit code are received, Step 646, client device 256 makes a determination as to whether the user unit code is the same as the user unit code stored in memory 415 of client device 256, Step 648. If the received user unit code is not the same as the user unit code stored in memory 415, the procedure is terminated, Step 650. However, if the received user unit code is determined in Step 648 to be the same as the user unit code stored in memory 415, actuator 422 of client device 256 is operated, Step 652 and the execution of the control command associated with the transaction is performed. Client device 256 then uses a predetermined algorithm to update the user unit code stored in memory 415 by changing the user unit code to the next non-sequential value, Step 654, and sends a control command acknowledgement message to server device 200 over the encrypted GPRS/EDGE cellular packet data network, Step 656.

As illustrated in FIG. 12, after transmitting the control command and user unit code to client device 256, Step 644 server device 200 makes a determination as to whether the control command acknowledgement message has been received, Step 658. If it is determined that the control command acknowledge message has not been received from client device 256, server device 200 then makes a determination as to whether timer 417 has expired, Step 660, and if timer 417 is determined to have expired, the process is terminated, Step 662. However, if it is determined in Step 658 that the control command acknowledgement message has been received from client device 256, server device 200 sends a message to man-machine interface 400, which then displays information informing the user that the entered command has been successfully performed, Step 664. Server device 200 stops timer 417, Step 666, and updates the user unit code stored in memory 413 by changing the user unit code to the next non-sequential value using the same predetermined algorithm used by client device 256, Step 668. In this way, by requiring receipt of the control command acknowledgement message to be received from client device within a predetermined time period, the present invention also protects against the retention of a false start, and once timer 417 is expired, the system is returned to a predictable state.

By enabling remote multiple access to a single SIM card device for simultaneous operation of multiple SIM enabled devices, the present invention creates a platform on which to construct new telephony and data services which were not previously possible in the known environment in which a SIM card is only accessible by a single user equipment device. As a result, the present invention enables the simultaneous operation of multiple devices by a single user, in different domains and for different purposes, on a single user subscription requiring authentication, via the device in which the SIM card is physically located. For example, the present invention enables simultaneous circuit-switched voice and packet-switched data services using multiple user devices so that a mobile device is able to operate a voice telephone while the same user operates a computer, within close proximity to the mobile device, for transmitting and receiving data. As a result, a single user is able to participate in a voice conversation while reading or writing electronic email, researching material on the Internet, and so forth.

Furthermore, by requiring both devices to have a priori knowledge of the user unit code and authentication procedures, the present invention reduces the probability of the integrity of information being compromised as a result of the interception and/or decoding of messages, and therefore increases security.

While a particular embodiment of the present invention has been shown and described, modifications may be made. It is therefore intended in the appended claims to cover all such changes and modifications that fall within the true spirit and scope of the invention.

What is claimed is:

1. A client device remotely accessing a packet data network through a server device, the client device comprising:
an actuator executing a control command input by a user; and
an authenticator application unit storing a user unit code received from the server device and comparing the stored user unit code with a user unit code received with the control command, wherein the actuator executes the control command in response to the stored user unit code being the same as the user unit code received with the control command.

2. The client device of claim 1, wherein the authenticator application unit updates the stored user unit code, using a predetermined algorithm for updating the user unit code at the server device, in response to the stored user unit code being the same as the user unit code received with the control command.

3. The client device of claim 1, wherein the user unit code is transmitted from the server device to the client device in response to a synchronization command transmitted from the client device to the server device over the packet data network.

4. The client device of claim 3, wherein the synchronization command is terminated in response to the user unit code not being received by the client device within a predetermined time period.

5. The client device of claim 1, wherein the authenticator application unit terminates execution of the control command in response to the stored user unit code not being the same as the user unit code received with the control command.

6. A mobile telecommunications system enabling a client device to remotely access a packet data network through a server device, comprising:
a first authentication application unit, positioned within the client device, transmitting a first synchronization command to the server device over the packet data network; and
a second authentication application unit, positioned within the server device, generating a user unit code and transmitting the generated user unit code to the client device over the packet data network in response to the first synchronization command, wherein the generated user unit code is stored by the client device and by the server device and the second authentication application unit transmits a message to the client device over the packet data network, the message including a control command and the user unit code stored in the server device, and wherein the first authentication application unit compares the user unit code received in the message with the user unit code stored in the client device and executes the control command in response to the user unit code stored in the client device being the same as the user unit code received in the message.

7. The mobile telecommunications system of claim 6, wherein the first synchronization command corresponds to a first user input to the client device, and wherein the second authentication application unit generates the user unit code in response to a second synchronization command corresponding to a second user input to the server device, the first and second synchronization commands corresponding to a synchronization process between the first and second authentication application unit, wherein the synchronization process is terminated in response to both the first and second synchronization commands not being input within a predetermined time period.

8. The mobile telecommunications system of claim 6, wherein, upon receipt of the generated user unit code, the first authentication application unit transmits an acknowledgement message to the second authentication application unit, and wherein the second authentication application unit terminates the synchronization process in response to the acknowledgement message not being received within the predetermined time period.

9. The mobile telecommunications system of claim 8, wherein the second authentication application unit stores the generated user unit code in response to the acknowledgement message.

10. The mobile telecommunications system of claim 6, wherein the first authentication application unit updates the user unit code stored in the client device using a predetermined algorithm and transmits an acknowledgement to the second authentication application unit over the packet data network in response to the user unit code stored in the client device being the same as the user unit code received in the message.

11. The mobile telecommunications system of claim 10, wherein the control command is terminated in response to the acknowledgement not being received by the second authentication application unit within a predetermined time period.

12. The mobile telecommunications system of claim 10, wherein the second authentication application unit updates the user unit code stored in the second application unit, using the predetermined algorithm, in response to the acknowledgement.

13. The mobile telecommunications system of claim 6, wherein the control command is terminated in response to the user unit code stored in the client device not being the same as the user unit code received in the message.

14. A method of authentication of a client device utilizing remote multiple access to a server device, comprising the steps of:
generating and transmitting a unique identifier over the packet data network between a client device and the server device;
storing the unique identifier at the client device and at the server device;
transmitting a control command including the identifier stored at the server device over the packet data network from the server device to the client device; and
determining at the client device whether the transmitted identifier is the same as the identifier stored at the client device and executing the control command in response to the transmitted identifier being the same as the identifier stored at the client device.

15. The method of claim 14, further comprising the step of updating the identifier stored at the client device and at the server device using a predetermined algorithm.

16. The method of claim 15, wherein the step of updating the identifier further comprises the steps of:
updating the identifier stored at the client device in response to the transmitted identifier being the same as the identifier stored at the client device;
transmitting an acknowledgement message over the packet data network from the client device to the server device; and
updating the identifier stored at the server device in response to the acknowledgement message.

17. The method of claim 16, wherein the control command is terminated in response to the acknowledgement message not being received at the server device within a predetermined time period.

18. The method of claim 14, wherein the control command is terminated in response to the transmitted identifier not being the same as the identifier stored at the client device.

19. The method of claim 14, wherein the step of generating and transmitting a unique identifier further comprises the steps of:
entering a synchronization command at the server device and the client device within a predetermined time period;
transmitting the synchronization command over the packet data network from the client device to the server device;
generating the identifier in response to receipt of the synchronization command by the server device and transmitting the identifier from the server device to the client device over the packet data network; and
transmitting an acknowledgement message from the client device to the server device over the packet data network in response to receipt of the identifier, wherein the identifier is stored at the server device in response to the acknowledgement message.

20. The method of claim 19, the step of generating and transmitting a unique identifier further comprising the steps of:
determining whether the synchronization command is received by the server device from the client device within the predetermined time period, and terminating the step of generating and transmitting a unique identifier in response to the synchronization command not being received by the server device from the client device within the predetermined time period;
determining whether the identifier is received at the client device within the predetermined time period, and terminating the step of generating and transmitting a unique identifier in response to the identifier not being received at the client device within the predetermined time period; and
determining whether the acknowledgement message is received at the server device within the predetermined time period, and terminating the step of generating and transmitting a unique identifier in response to the acknowledgement message not being received at the server device within the predetermined time period.
